(19) United States
(12) Patent Application Publication
(10) Pub. No.: US 2018/0181647 A1
(43) Pub. Date: Jun. 28, 2018

(54) System and Method for Editing a Linked List

(71) Applicant: CERNER INNOVATION, INC., Kansas City, KS (US)

(72) Inventor: Mohammad Zahidul Haque, Bengaluru (IN)

(21) Appl. No.: 15/392,099

(22) Filed: Dec. 28, 2016

(51) Int. Cl. G06F 17/30

(52) U.S. Cl. CPC G06F 17/30622

(57) ABSTRACT

Computer systems, methods and computer readable media useful with linked lists are provided. One or more computer processors on one or more computing devices programmed to maintain a linked list of multiple nodes. Each node in the linked list contains a reference to the following node. A double ended queue (deque) creates corresponding indexes for the linked list. Each index comprises a defined number of nodes from the linked list. The system and method also maintains a pointer to the last node of the linked list. Rather than traversing each individual node to find a position, the multiple indexes are traversed to reach and insertion or deletion position. After arriving at the position, the new node is inserted or node is deleted from the position. This process significantly reduces CPU cycle time, memory usage and time to traverse the linked list.

### BACKGROUND

Many applications in computer science use linked lists, including communications systems, operating systems, device drivers and medical information workflows.

A linked list is a linear collection of data elements, called nodes, each node pointing to the next node using a pointer. This data structure of nodes represents a sequence. Each node is composed of data and a reference to the next node.

### SUMMARY

The linked list structure allows for nodes to be inserted and removed from any position in the sequence. Linked lists are sequence containers that allow constant time insert and erase operations anywhere in the sequence. The main drawback of lists and forward lists (they are implemented as single-linked lists) compared to these other sequence containers is that they lack direct access to the nodes by their position. For example, to access the sixth node in a list, one has to iterate from a known position (like the beginning or the end) to that position, which takes linear time in the distance between these. The present invention applies to both singly and doubly linked lists.

Computer systems, methods and computer readable media useful with linked lists are provided. One or more computer processors on one or more computing devices programmed to maintain a linked list of multiple nodes. Each node in the linked list contains a reference to the following node. A double ended queue (deque) creates corresponding indexes for the linked list. Each index comprises a defined number of nodes from the linked list. The system and method also maintains a pointer to the last node of the linked list. Rather than traversing each individual node to find a position, the multiple indexes are traversed to reach and insertion or deletion position. After arriving at the position, the new node is inserted or node is deleted from the position. This process significantly reduces CPU cycle time, memory usage and time to traverse the linked list.

The claimed solution is necessarily rooted in improving the function of a central processing unit (CPU) technology, and the claims address the problem of reducing CPU cycle time and memory usage when utilizing a linked list. If adhering to the routine, conventional function of adding nodes to a linked list requires traversing the nodes of a linked list and wastes time and processing speed of a CPU. The claimed invention overcomes the limitations of current computer technology and provides other benefits that will become clear to those skilled in the art from the foregoing description.

The claimed computerized system and method of the present application represents a new paradigm of adding and deleting nodes to a linked list. Not only do the linked lists of the claimed invention keep track of free blocks in operating systems, linked lists are used to implement stacks, queues and graphs in a medical computing environment. Adding and deleting nodes according to the present invention saves significant processing time in reducing the memory utilization, CPU cycles, number of operations that need to be performed by the computer, and power consumption.

### BRIEF DESCRIPTION OF THE DRAWINGS

FIG. 1 is a block diagram of an exemplary computing environment suitable to implement embodiments of the present invention;

FIG. 2 is an exemplary system architecture suitable to implement embodiments of the present invention;

FIGS. 3-4 are graphical representations depicting a decrease in memory usage with the current implementation vs. the prior technology; and

FIGS. 5-6 are graphical representations depicting a decrease in CPU usage with the current implementation vs. the prior technology.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, systems, and computer-readable media for a system and method for accessing nodes in a linked list. One or more computer processors on one or more computing devices programmed to maintain a linked list of multiple nodes. Each node in the linked list contains a reference to the following node. A double ended queue (deque) creates corresponding indexes for the linked list. Each index comprises a defined number of nodes from the linked list. The system and method also maintains a pointer to the last node of the linked list. Rather than traversing each individual node to find a position, the multiple indexes are traversed to reach and insertion or deletion position. After arriving at the position, the new node is inserted or node is deleted from the position. This process significantly reduces CPU cycle time, memory usage and time to traverse the linked list.

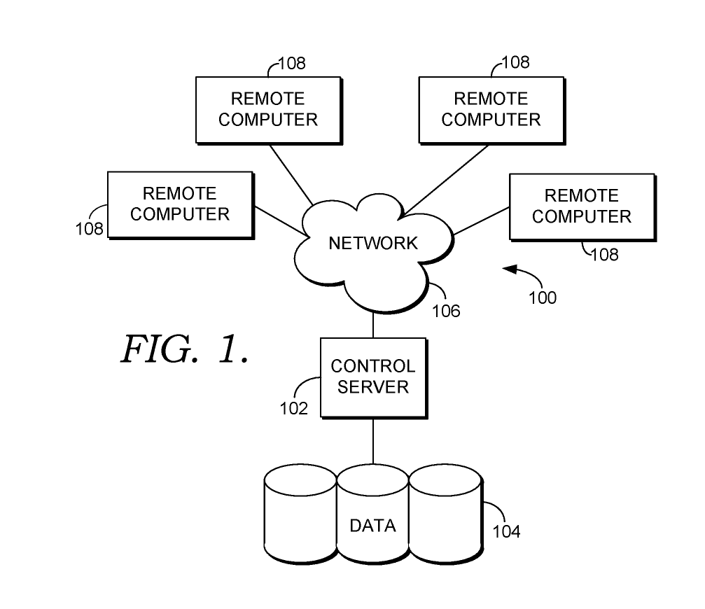

With reference to FIG. 1, an exemplary computing environment suitable for use in implementing embodiments of the present invention is described below. An exemplary computing environment (e.g., medical-information computing-system environment) with which embodiments of the present invention may be implemented is provided. The computing environment is merely an example of one suitable computing environment and is not intended to suggest any limitation as to the scope of use or functionality of the invention. Neither should the computing environment be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

The computing environment comprises a computing device in the form of a control server 102. Exemplary components of the control server comprise a processing unit, internal system memory, and a suitable system bus for coupling various system components, including data stores, with the control server. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of non-transitory computer-readable media. Computer-readable media can be any available media that might be accessed by control server, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network using logical connections to one or more remote computers 108. Remote computers 108 might be located at a variety of locations including operating systems, device drivers and medical information workflows. The remote computers might also be physically located in traditional and nontraditional medical care environments so that the entire healthcare community might be capable of integration on the network. The remote computers might be personal computers, servers, routers, network PCs, peer devices, other common network nodes, or the like and might comprise some or all of the elements described above in relation to the control server. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server, the data store 104, or any of the remote computers. For example, various application programs may reside on the memory associated with any one or more of the remote computers 108. It will be appreciated by those of ordinary skill in the art that the network connections shown are exemplary and other means of establishing a communications link between the computers (e.g., control server and remote computers) might be utilized.

In operation, an organization might enter commands and information into the control server or convey the commands and information to the control server via one or more of the remote computers through input devices, such as a keyboard, a microphone (e.g., voice inputs), a touch screen, a pointing device (commonly referred to as a mouse), a trackball, or a touch pad. Other input devices comprise satellite dishes, scanners, or the like. Commands and information might also be sent directly from a remote healthcare device to the control server. In addition to a monitor, the control server and/or remote computers might comprise other peripheral output devices, such as speakers and a printer.

Although many other internal components of the control server and the remote computers are not shown, such components and their interconnection are well known. Accordingly, additional details concerning the internal construction of the control server and the remote computers are not further disclosed herein.

The methods, systems and computer readable media, described herein, are directed to improving CPU and memory usage. As described in more detail herein, embodiments of the present invention improve the functioning of a computer itself. In particular, the extensible data structures for rule based systems described herein improve the processing time and throughput of a rules based system.

Computer systems, methods and computer readable media are provided for inserting a new node in a linked list. A linked list is a linear collection of data elements, called nodes, each node pointing to the next node using a pointer. This data structure of nodes represents a sequence. Each node is composed of data and a reference to the next node.

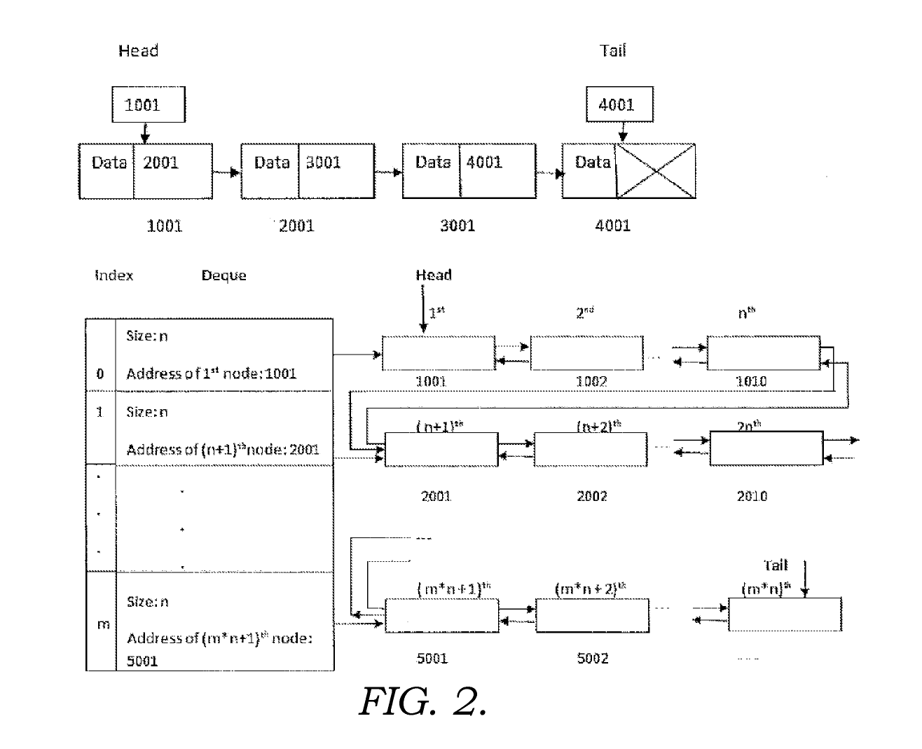

A linked list of multiple nodes is provided and an exemplary linked list is shown in FIG. 2. As can be seen at the top of the page, the first node (head) of the linked list is 1001. The last node (tail) is 4001. Each node is comprised of data and a link to the next node. Node 1001 includes data and a link to the next node 2001. Node 2001 is after node 1001 and includes data and a link to the next node 3001. This goes until the last node 4001 of the linked list is reached.

Embodiments include creating an index of the nodes in a linked list in a double ended queue (deque) or equivalent data index. The double ended queue can be used with multiple computer languages, including C++, Java and the like. As shown in FIG. 2, the index starts with the address of the first node (1001) of a linked list. The index also defines the number of nodes (n) per index of the double ended queue. For example, in the embodiment of FIG. 2, each index is 1000 nodes long. As such index 0 is nodes 1000-2000, index 1 is nodes 2001 to 3000. The index number is defined as m and n is the number of nodes per index.

Multiple indexes as shown in FIG. 2, are created in a double ended queue (deque) for the linked list, wherein each index comprises a defined number of nodes (n) from the linked list. The address of the first node in the index (address of 1^{st} node 1001 in index 0, address of 1^{st} node in index 1, 2001) of each index is maintained in the double ended queue as well as the size of the index (n). The double ended queue maintains a pointer to the last node (tail) of the linked list. If the last node of the linked list changes, the pointer is updated to reflect the new last node. For example, if a node is added in position 4002 after 4001 (prior last node) in the above example, the pointer is updated to reflect that the 4002 is the new last node. Thus, if nodes are to be added to the linked list at the end of the linked list, the entire linked list does not have to be traversed to get to the last node of the list, the last node is immediately pointed to in the double ended queue.

Typically, if a new node is to be added to a random position in the linked list or at end the linked list, each node has to be traversed, requiring O(n) time, to reach the random position or the end of the list. With the present system and method, by maintaining an index of the linked list and a pointer to the last element, nodes can be added without traversing the linked list and nodes can be added/deleted from the linked list in constant time O(1). Since an end node pointer is maintained in the index, all the nodes do not need to be traversed to reach the end of the linked list, reducing time, memory and usage of a CPU.

If the proposed system and method is to maintain information for a total of 1000 nodes of a linked list and n=10 (=1000/100), in a double ended queue. Thus, the 1^{st} index of deque will have the address of the 1^{st} node of linked list and the size (n)=10, the second index will have the address of the 11^{th} node of the linked list and size (n)=10. The method and system keeps the address of the first node of each index and subsequently the address of the (m*n+1)th node in each index of deque where m and n>0.

In a Big O notation example, the system and method maintains a pointer that points to the last element of the linked list. Now using this pointer, one can add a new element or delete an already existing element at the end of the linked list in O(1), pronounced as Big “Oh”, constant time. Big O notation is used to find out the complexity of an algorithm. Adding an element at the beginning of a linked list is always O(1) time, in existing methodology.

This comparison is done with the existing Standard Template Library's list container is implemented as a doubly linked list (STL library list). The first case uses the prior existing solution and the second case uses the system and method of the claimed invention. Testing was done with the following system configurations

### System

Rating: System rating is not available

### Processor: Intel(R) Xeon® CPU X5680 @ 3.33 GHz 3.4 GHz

Installed memory (RAM): 8.00 GB
System type: 64-bit Operating System

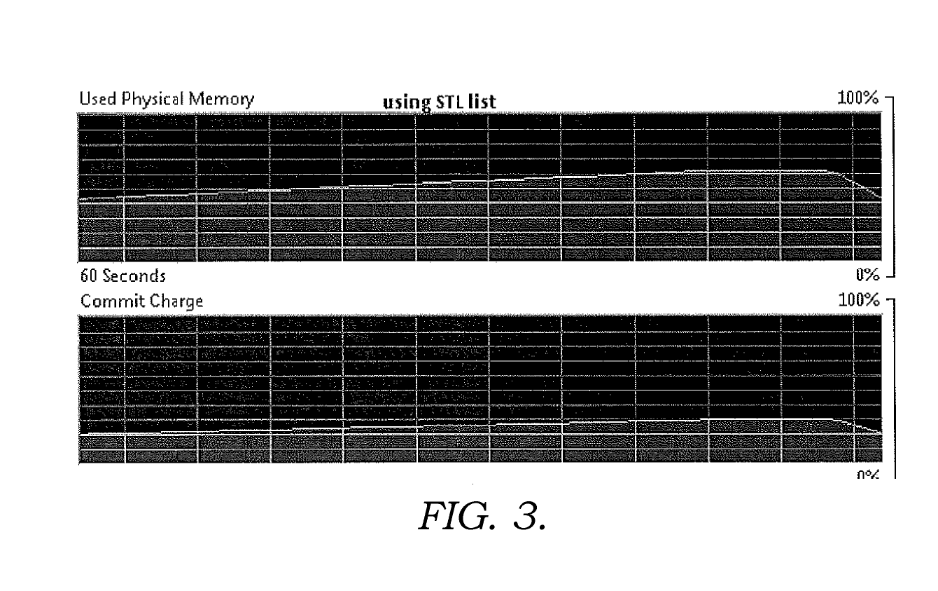

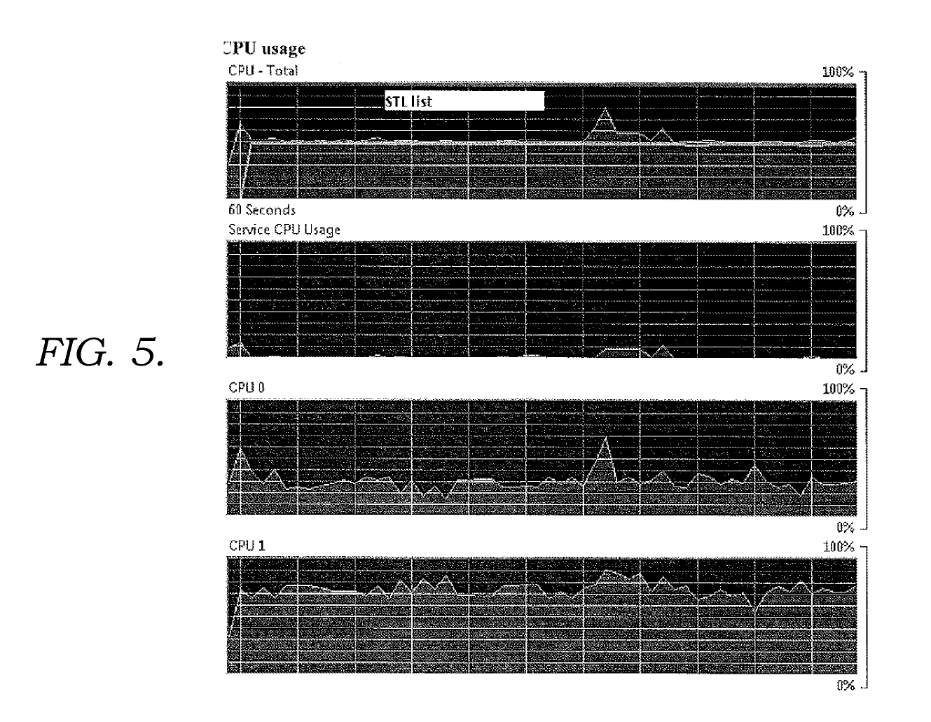

Case I: With current existing solution the memory and CPU usage are shown in FIG. 3 and FIG. 5

Suppose there are 30,000,000 nodes in a list and we want to insert an element at position 1,500,001. Then to insert an element at this position I need to traverse 1,500,000 nodes to reach this position. Assuming that to traverse 1 node takes 1 micro sec, then to traverse to this position will take 1,500,000*10̂−6 sec=1.5 sec.

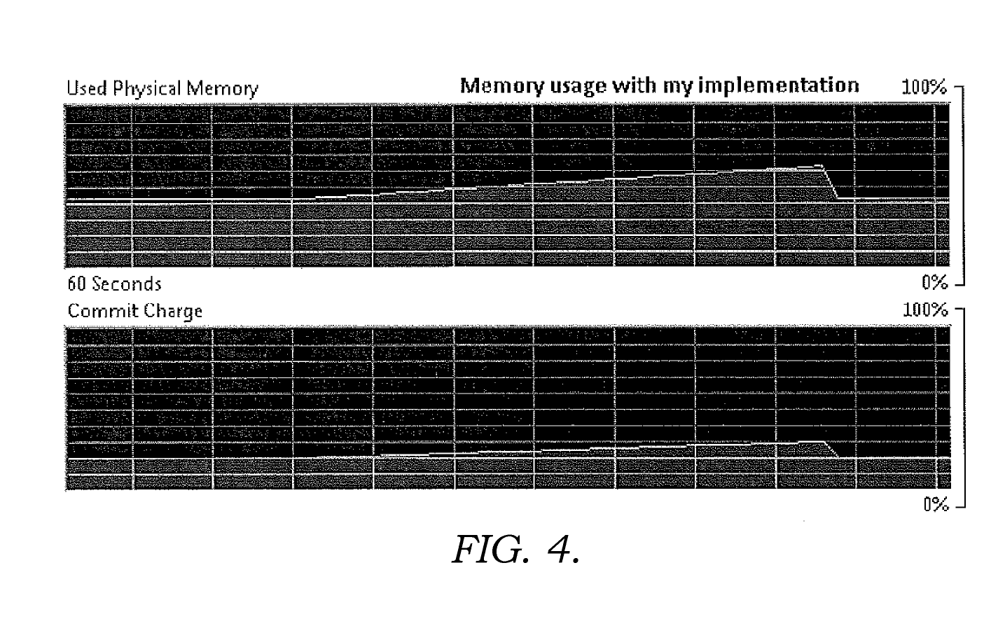

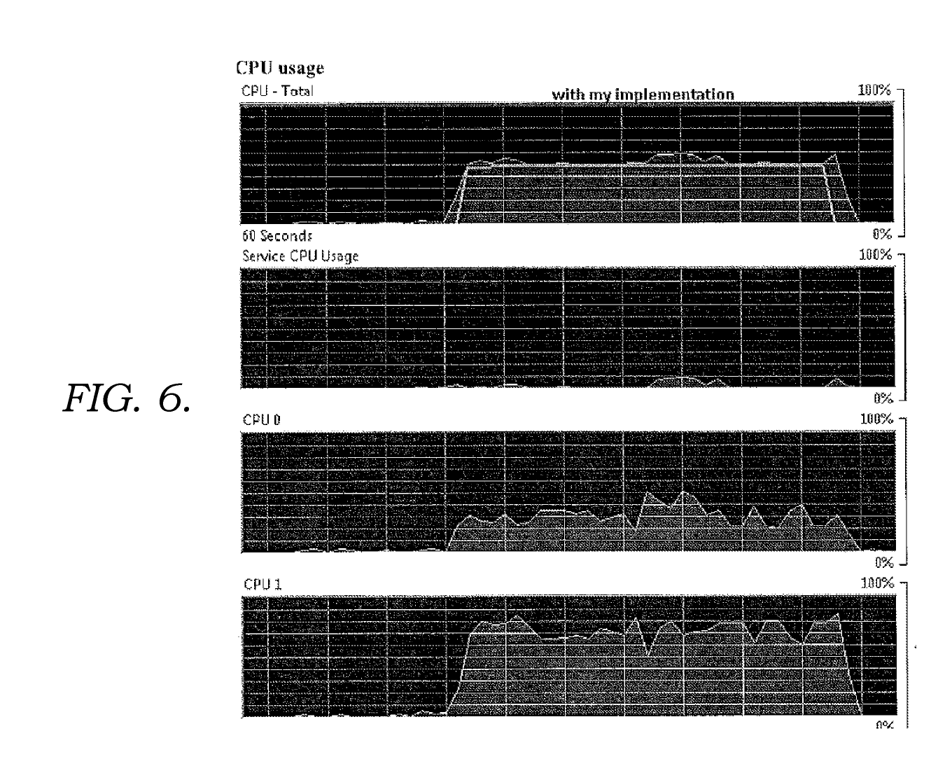

Case II: Using the system and method of the present invention includes a solution that uses Deque for maintain the index of linked list. The memory and CPU usage using the new method and system are shown in FIG. 4 and FIG. 6

n=30,000,000 nodes in the list.

p=1,500,001th position for insertion

With this new implementation, 10,000 nodes are maintained for each index in Deque. So only 3,000 indexes i.e. (30,000,000/10,000=3,000) are required for Deque to maintain this huge linked list. The new element is to be inserted at 1,500,001 position and will be at 150th index in Deque.

To insert at this position, we need to traverse only 150 indexes of Deque. Assuming that to traverse 1 node takes 1 micro sec, and then to traverse at this position will take 150*10̂−6 sec=0.0015 sec only. The same will be true for deleting a node from a deletion position “d” from a linked list as well.

From the data provided, it is clear that there is a huge difference between the two methods. As can be seen in FIGS. 3-6 the new system and method significantly decreases the memory usage and SPU usage of the Intel (R) Xeon CPU. With the new system and method, inserting an element at any position will not be O(n), assuming ‘n’ is the total number of nodes in the linked list. With the new system and method of an STL library list, though inserting of element at any position is O(1), but reaching that position is always going to be O(p), assuming new node is going to be inserted at pth position.

Also if there are no nodes in the STL library and the previous method tries to insert a node at any random position, it will crash the CPU. However, with the new system and method the program never crashes and inserts the nodes as the first element of the linked list. If there is only one node present, then the new node will always be inserted at the end if user specifies any position except 0 and 1st.

In another example, to insert at 1,500,001th position 100 times in the existing STL library list, the program will crash. But, with the new algorithm this will not happen.

Systems, methods and computer readable media are provided inserting and deleting new nodes in a linked list. As described above and shown in FIG. 2, a linked list of multiple nodes is provided. Multiple indexes in a double ended queue (deque) are created for the linked list. Each index in the double ended queue comprises a defined number of nodes (n) from the linked list as shown in FIG. 2. The double ended queue maintains the address of the first node of each index of the linked list. When a new node is to be deleted or added to the linked list, the multiple indexes in the double ended queue are traversed to an insertion or deletion position. The new node is inserted at the insertion position in the linked list and deleted from the deletion position. After traversing the multiple indexes in the double ended queue, the new node is inserted into the linked list at the insertion position or deleted from the deletion position. The multiple indexes in the double ended queue are traversed, rather than the linked list, to reach the insertion or deletion position to reduce CPU cycle time and memory usage.

If in FIG. 2, a new node is added to the last node of a linked list, the pointer is updated to reference the new last node as the last node of the linked list. Furthermore, the pointer us updated to the new last node when the node the end of the linked list is deleted.

The claimed invention overcomes the limitations of adding and deleting nodes from linked list and provides other benefits that will become clear to those skilled in the art from the foregoing description.

I claim:

1. A computer system useful with a linked list of nodes, the system comprising:
one or more computer processors on one or more computing devices programmed to:
maintain a linked list of multiple nodes,
create corresponding indexes in a double ended queue (deque) for the linked list, wherein each index comprises a defined number of nodes from the linked list;
for each index, maintain an address of the first node of each index;
maintain a pointer in the double ended queue to the last node of the linked list;
traverse the multiple indexes in the double ended queue, rather than the linked list, to reach an insertion position of the linked list for a new node to be inserted; and
after traversing the multiple indexes in the double ended queue, inserting the new node at the insertion position.

2. The system of claim 1, wherein traversing the multiple indexes in the double ended queue as opposed to traversing the linked list reduces CPU cycle time and memory usage.

3. The system of claim 1, further comprising:
updating the pointer to the new node when the new node is inserted at the end at the end of the linked list.

4. The system of claim 1, wherein “n” is number of nodes per index.

5. The system of claim 4, further comprising:
updating the number of indexes when “n” number of nodes have been added to the linked list.

6. The system of claim 5, further comprising:
receiving a random position for insertion of the new node, wherein “p” is the position for insertion.

7. The system of the claim 1, wherein each node of the linked list comprises data and a reference to the next node.

8. The system of claim 7, wherein by maintaining an index of the linked list and a pointer to the last element, nodes can be added without traversing the linked list and nodes can be added/deleted from the linked list in constant time O(1).

9. The system of claim 1, wherein direct access to the nodes is provided by maintaining the double ended queue and indexes.

10. A computer system useful with a linked list of nodes, the system comprising:
one or more computer processors on one or more computing devices programmed to:
maintain a linked list of multiple nodes,
create corresponding indexes in a double ended queue (deque) for the linked list, wherein each index comprises a defined number of nodes from the linked list;
for each index, maintain an address of the first node of each index;
maintain a pointer in the double ended queue to the last node of the linked list;
traverse the multiple indexes in the double ended queue, rather than the linked list, to reach a deletion position of the linked list for a node to be deleted from the linked list; and
after traversing the multiple indexes in the double ended queue, deleting the node at the deletion position.

11. The system of claim 10, wherein traversing the multiple indexes in the double ended queue as opposed to traversing the linked list reduces CPU cycle time and memory usage.

12. The system of claim 10, further comprising:
updating the pointer to the new last node when the node the end of the linked list is deleted.

13. The system of claim 10, wherein “n” is number of nodes per index.

14. The system of claim 13, further comprising:
updating the number of indexes when “n” number of nodes have been deleted from the linked list.

15. The system of claim 14, further comprising:
receiving a random position for deletion of a node, wherein “d” is the position for deletion.

16. The system of the claim 15, wherein each node of the linked list comprises data and a reference to the next node.

17. The system of claim 16, further comprising:
updating the node previous to the deleted node to reference the node that followed the deleted node.

18. The system of claim 17, wherein by maintaining an index of the linked list and a pointer to the last element, nodes can be added without traversing the linked list and nodes can be added/deleted from the linked list in constant time O(1).

19. The system of claim 10, wherein direct access to the nodes is provided by maintaining the double ended queue and indexes.
